(19) United States
(12) Patent Application Publication
(10) Pub. No.: US 2008/0284245 A1
(43) Pub. Date: Nov. 20, 2008

(54) Machine track system and machine track segment

(75) Inventors: Richard E. Livesay, Peoria, IL (US); Everett G. Brandt, Brimfield, IL (US); David A. Lapen, Peoria, IL (US); Glen A. Spindel, Divernon, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(73) Assignee: Caterpillar Inc.

(21) Appl. No.: 11/804,564

(22) Filed: May 18, 2007

(51) Int. Cl. B62D 55/08; B62D 55/12

(52) U.S. Cl. 305/193; 305/201

(57) ABSTRACT

A machine track system includes a track with track shoes each having a footprint, and a ground contact area equal to the footprint, the track shoes being coupled together by a total of two track chains. A first rail and a second rail are located between first and second outboard edges of each of the track shoes, such that track rollers roll directly on the track shoes. The track chains are spaced outboard of the rails, and a guide block configured to engage with an idler and a drive sprocket is positioned between the respective rails. A sprocket and idler for use with the track system includes removable track contacting segments having pockets configured to receive the guide blocks for driving and guiding the track.

### TECHNICAL FIELD

The present disclosure relates generally to machines and machine track systems, and relates more particularly to a machine and track system that includes track shoes with integral rails coupled together with a total of two outboard track chains of side-by-side links.

### BACKGROUND

Tracks are used as ground engaging elements in a wide variety of machines, notably construction and earth moving machines and those operating in similarly rugged environments. Tracks used in such “track-type” machines generally consist of endless loops of coupled together track shoes extending about a plurality of rotating elements, forming part of the machine undercarriage that propels the machine and supports the operator cab, implement system, etc. Track chains, consisting of coupled links, connect the track shoes and typically provide rails for track rollers which support the machine and guide the tracks along desired paths as the machine traverses a work surface. Certain machines, and in particular excavating machines, are often used in applications with relatively soft underfoot conditions, such as swampy environs. Track-type machines operating in soft underfoot conditions are often equipped with tracks having a relatively large ground contact area for distributing the weight of the machine. In particular, track shoes are often used which are relatively wider than track shoes used in other types of applications, distributing ground pressure across a relatively greater surface area and reducing a tendency to sink and create ruts in the ground surface. While a wide variety of systems have been successful, such track designs present unique challenges.

One problem associated with the use of low ground pressure tracks is the tendency for mechanical strain on the track to result in bending and/or separation of parts under certain conditions. For instance, when an excavator positions one of its relatively wide tracks on top of a relatively hard, solid object such as a stump or upwardly protruding rock in otherwise soft underfoot conditions, a track shoe supported on the stump, rock, etc. can be twisted, bent or otherwise displaced from a desired position relative to adjacent track shoes. Weight of the machine can force certain track shoes down, while the rock, etc. continues to support one or more of the other track shoes, resulting in disparate vertical positions of parts of the track. This phenomenon is particularly evident where a machine is experiencing heavy vertical loading, as can occur during excavating work, and can place substantial strain on track components, in some instances leading to premature failure.

One means for dealing with the above mentioned problem in relatively wider tracks has been to make the tracks highly robust to resist bending, twisting, separation, etc. of the track components. One design utilizes a total of four track chains coupling together the shoes of each track. First and second track chains are positioned at outboard edges of each track, whereas third and fourth track chains are positioned between the outboard track chains and include rails to support track rollers thereon. The use of four track chains provides an extremely strong track, resistant to mechanical deformation and damage that can result from uneven ground conditions, objects and demanding operating practices. A shortcoming of such a design, however, is that the use of four track chains adds undesired weight, complexity and expense to the track.

Another relatively wide track design is known from U.S. Pat. No. 3,913,986 to Schaffner. Schaffner provides a short pitch, high-speed track purportedly of high efficiency and low noise level. Schaffner utilizes a shoe having wear surfaces for track rollers. This enables Schaffner's track to be utilized with outboard track chains and track rollers which ride directly on the wear surfaces. Schaffner is poorly suited for certain applications, however, due to its use of a discontinuous ground contact area on each of the shoes. Moreover, Schaffner's track chains are quite complex, using numerous small parts and making such a design not only expensive, but also difficult to assemble and seal.

The present disclosure is directed to one or more of the problems or shortcomings set forth above.

### SUMMARY OF THE INVENTION

In one aspect according to the present disclosure, a machine track system includes a plurality of track shoes having a first outboard edge and a second outboard edge, each of the track shoes further including a first rail and a second rail located between the first and second outboard edges. A plurality of guide blocks are coupled one with each of the shoes and positioned between the rails, the plurality of track shoes being coupled together with a total of two track chains, including a first track chain spaced outboard of the first rail and a second track chain spaced outboard of the second rail. The track chains each include a plurality of links having first and second ends, the ends of each link being arranged side-by-side with ends of adjacent links and coupled therewith via track pins.

In another aspect, a machine includes a frame and at least one track coupled with the frame. The at least one track includes a plurality of track shoes each having a first outboard edge and a second outboard edge, the track shoes having rails located between the respective first and second outboard edges. The machine further includes a plurality of guide blocks coupled one with each of the track shoes and positioned between the rails thereof, and a plurality of track rollers contacting the rails. A first track chain and a second track chain are further included, the track chains being spaced from the rails and each including a plurality of coupled together links having ends arranged side-by-side with ends of adjacent links and coupled therewith via track pins.

In still another aspect, a machine track segment includes a track shoe having a plurality of peripheral edges defining a footprint, including a first outboard edge, a second outboard edge, a front edge and a back edge. The track shoe has a length extending between the front and back edges, a width extending between the first and second outboard edges which is at least twice the length and a ground contact area equal to the footprint. A guide block is positioned between the first and second outboard edges, and at least one pad is provided adjoining the guide block. The at least one pad has a width less than one third the width of the track shoe, and includes a first rail positioned between the guide block and the first outboard edge and a second rail positioned between the guide block and the second outboard edge. The track shoe is adapted to couple with adjacent track shoes of a machine track via a total of two track chains separate from and spaced outboard of the rails.

### BRIEF DESCRIPTION OF THE DRAWINGS

FIG. 1 is a diagrammatic view of a machine according to one embodiment;

FIG. 2 is an isometric view of a partially disassembled machine undercarriage according to one embodiment;

FIG. 3 is an isometric view of a machine track segment according to one embodiment;

FIG. 4 is a sectioned view of a portion of a machine undercarriage according to one embodiment;

FIG. 5 is a sectioned view of another portion of a machine undercarriage according to one embodiment;

FIG. 6 is a pictorial view of an idler according to one embodiment;

FIG. 7 is an isometric view of a machine track segment according to one embodiment;

FIG. 8 is a sectioned view of a portion of the machine track segment shown in FIG. 7; and

FIG. 9 is a partially sectioned side view taken along line 9-9 of FIG. 7.

### DETAILED DESCRIPTION

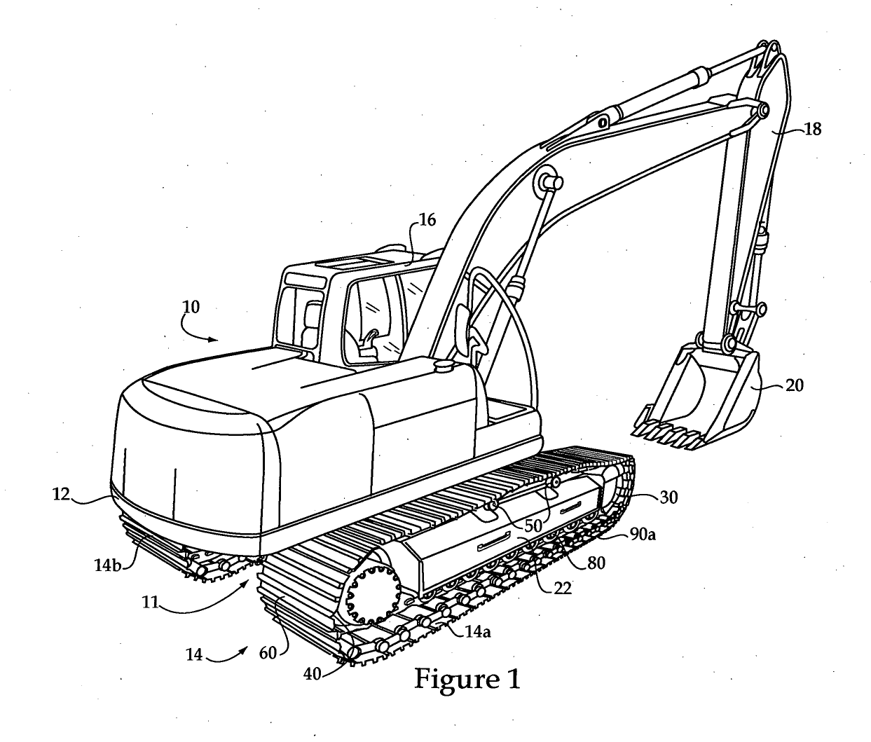

Referring to FIG. 1, there is shown a machine 10 having a frame 12 with a track system 14, including a first track 14a and a second track 14b positioned at opposite sides of frame 12. Machine 10 is shown in the context of an excavator having an operator cab 16, a linkage 18 and an implement 20 coupled with linkage 18. Tracks 14a and 14b are part of a machine undercarriage 11 coupled with frame 12 in a conventional manner. Each of tracks 14a and 14b include a plurality of coupled together track shoes 60 forming endless loops extending about a plurality of rotatable elements. In a typical design, an idler 30 and a drive sprocket 40 will be associated with each of tracks 14a and 14b and mounted to a track roller frame 22. A plurality of track rollers 80 may also be mounted to roller frame 22, and are associated with each of tracks 14a and 14b to support machine 10 and guide tracks 14a and 14b in desired paths, as further described herein. One or more carrier rollers 50 may also be associated with each of tracks 14a and 14b to support and guide the tracks opposite rollers 80 during operation. The unique design of tracks 14a and 14b and the overall track and undercarriage system of which they are a part are contemplated to enable machine 10 to operate in certain environments such as soft underfoot conditions without the shortcomings associated with many earlier designs. While use in the machine environment of an excavator is emphasized herein, it should be understood that machine 10 might comprise a different type of machine. For instance, track-type tractors or even half-track machines are contemplated herein. Further still, machine 10 might consist of a conveyor or other type of machine wherein tracks are used for purposes other than as ground engaging elements.

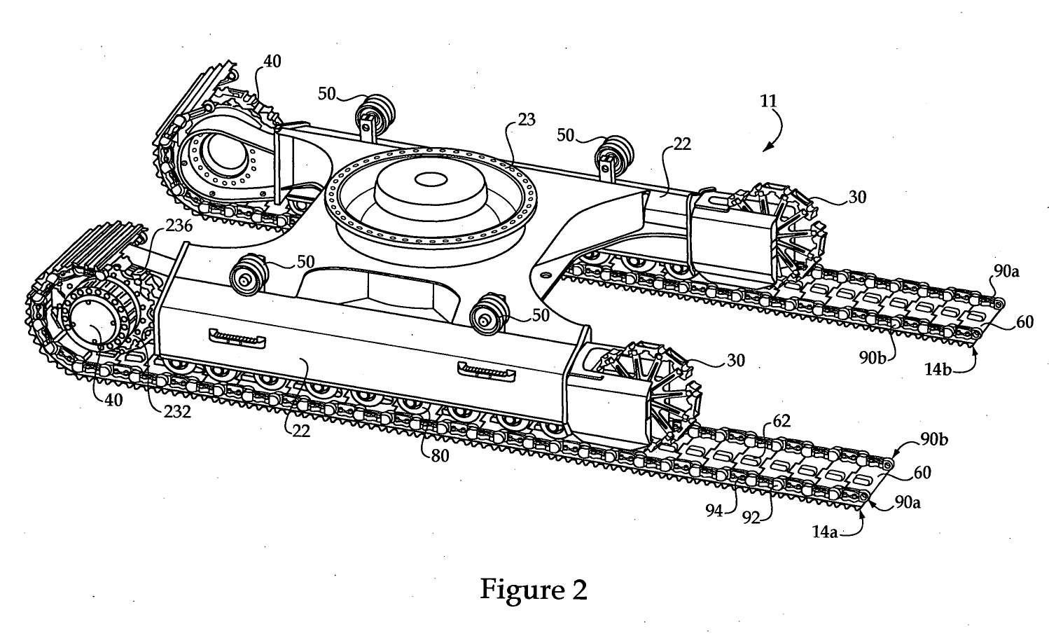

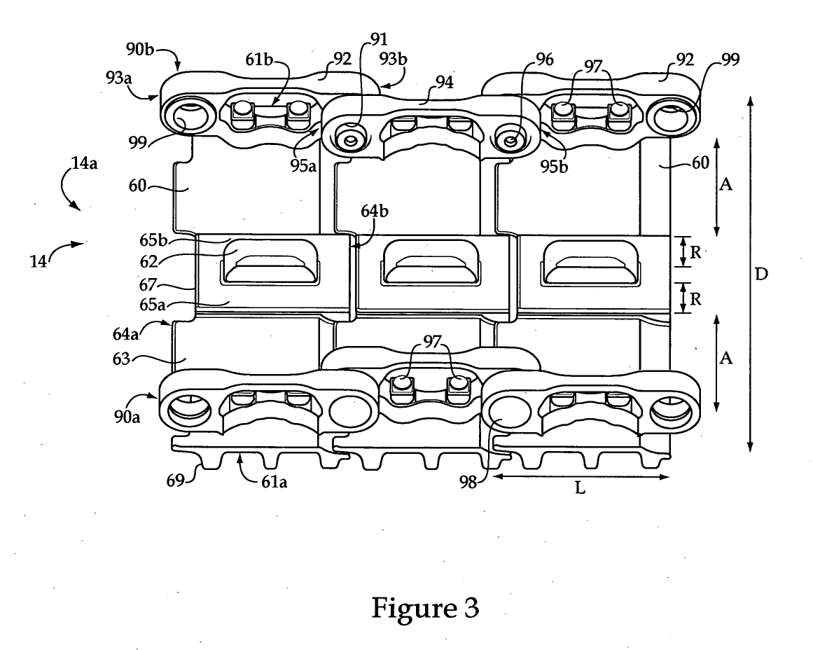

Referring now also to FIG. 2, there is shown machine undercarriage 11 partially disassembled, showing portions of track roller frame 22 and a carbody 23. Each of tracks 14a and 14b may include a first track chain 90a and a second track chain 90b. In one embodiment, each track chain 90a and 90b may be positioned at or close to opposite edges of each track shoe 60 making up the respective track. Each of track chains 90a and 90b may consist of alternating inboard links 94 and outboard links 92. Referring also to FIG. 3, there is shown a segment of track 14a, representative of any portion thereof, and substantially identical to any segment of track 14b. The segment of track 14a shown in FIG. 3 includes three coupled together track shoes 60, each having one track link of first track chain 90a and one track link of second track chain 90b coupled therewith. Each of the respective track links may be bolted to the corresponding track shoe with bolts 97. In other embodiments, described herein, integral track links and track shoes may be used.

It will further be noted from the FIG. 3 illustration that each track link may include opposite ends positioned adjacent ends of successive track links in the corresponding track chain. In particular, each outboard track link 92 may include a first end 93a and a second end 93b opposite first end 93a. Each inboard link 94 may also include a first end 95a and a second end 95b. The respective track links may be positioned such that their ends are located adjacent ends of adjacent track links in a side-by-side arrangement. It should be understood that a side-by-side arrangement of link ends as contemplated herein would not include a fork and blade link configuration, and would not include links otherwise having multiple separate parts engaged with adjacent links. Links having their ends arranged in a side-by-side manner could be, however, either straight or S-shaped links, for example. Track pins 96 may extend through adjacent track link ends to couple the track links, and in turn adjacent track shoes, together. Each of inboard links 94 may include bores 91 in each of ends 95a and 95b wherein a track pin 96 is press fitted. Each outboard link 92 may include another bore 99 in each of its ends 93a and 93b wherein a track pin 96 is loose-fitted. Snap-rings, keepers or some other pin retention mechanism may be used to inhibit pins 96 from slipping out of bores 99. End caps 98 may be used to seal bores 99 to retain lubricating fluid therein and enable access for service, etc. In one embodiment, links 92 and 94 may be formed with a single forging die, and their respective bores, etc., formed via machining to obtain different sizes for press-fits versus loose fits.

Among other things, the present disclosure provides a track system, one embodiment of which is shown in FIG. 3, which differs from known track designs in that the respective track chains 90a and 90b serve only to couple together the sets of track shoes 60. Also in contrast to earlier designs, the track chains do not include rails upon which track rollers ride. Instead, track rollers 80 ride directly on portions of track shoes 60. This strategy allows track chains 90a and 90b to be relatively simpler and lighter than conventional track chain designs. Track chains 90a and 90b may also be positioned adjacent a first outboard edge 61a and a second outboard edge 61b of each of track shoes 60. Positioning track chains 90a and 90b close to the respective outboard edges 61a and 61b will enable track chains 90a and 90b to inhibit flexing and separating of track shoes 60 during certain operating conditions such as during high vertical loading and in response to certain mechanical stresses. In particular, where one of track shoes 60 is positioned upon a relatively hard supporting object such as a stump or stone, chains 90a and 90b can inhibit separating or creation of gaps between track shoes 60 due to stresses placed thereon, as described above in relation to earlier track designs.

As mentioned above, track rollers 80 ride directly on track shoes 60. Each track shoe 60 may include an upper side 63 having a pad 67 positioned thereon. Pad 67 may include a first rail 65a and a second rail 65b, configured to support a track roller during operation. A guide block 62 may also be adjoined by each pad 67 and may comprise an integral part of, or be positioned upon, each pad 67. Each guide block 62 can provide guiding for track rollers as well as drive surfaces for the corresponding track, as further described herein. Each pad 67 may extend approximately from a front edge 64a of each track shoe 60 to a back edge 64b of the corresponding track shoe. In one embodiment, a pad 67 may be formed integrally with each track shoe 60, such as by casting, forging, etc. Each guide block 62 may also be formed integrally with a pad 67. Integral pad and block elements could be keyed to and bolted on track shoes 60 in certain embodiments. In most versions, each pad 67 will provide a thickened region of wear material for wearing against track rollers. In other embodiments, however, pads 67 need not include a thickened wear region at all. Although pads 67 will typically be rectangular, in other embodiments they might have alternative shapes. Pads 67 will typically have a width defined by outboard edges of rails 65a and 65b which is less than one third a width D of the corresponding track shoe. The term pad should thus be understood to refer generally to a region of each track shoe, or a part or region of a part coupled therewith, which provides rails 65a and 65b for track rollers, without limitation as to shape or construction.

It will be further noted that rails 65a and 65b are positioned outboard of each guide block 62 and positioned inboard of each track chain 90a and 90b. In one embodiment, each of rails 65a and 65b may have a width, shown via arrows R in FIG. 3, which is less than a distance by which the closest outboard track chain 90a, 90b is spaced therefrom. In other words, each of track chains 90a and 90b may be spaced an average distance from rails 65a and 65b, respectively, which is greater than the width R of the corresponding rail. In certain embodiments, track chains 90a and 90b may be spaced an average distance, respectively, from rails 65a and 65b which is more than twice a width of the corresponding rail. The distance whereby track chains 90a and 90b are spaced from rails 65a and 65b is shown in FIG. 3 via arrows A. Also apparent from the FIG. 3 illustration are certain of the relative dimensional characteristics of each track shoe 60. It will be noted that each track shoe 60 has a length, shown via arrow L, which is less than one half its width, shown via arrow D in FIG. 3.

As alluded to above, tracks 14a and 14b are considered to be well suited for work in soft underfoot conditions. To this end, tracks 14a and 14b may be “low ground pressure” tracks, each having track shoes 60 with a relatively large ground contact area for distributing pressure from the weight of machine 10 across a relatively large surface area. Each of track shoes 60 has a footprint defined in part by front and back edges 64a and 64b, and also defined in part by outboard edges 61a and 61b. Each of track shoes 60 may further include a ground contact area that is equal to its footprint, or less than its footprint only to an extent that adjacent track shoes overlap one another. Grousers 69 are associated with each of track shoes 60 and may extend downwardly from a lower side thereof, which is positioned opposite upper side 63.

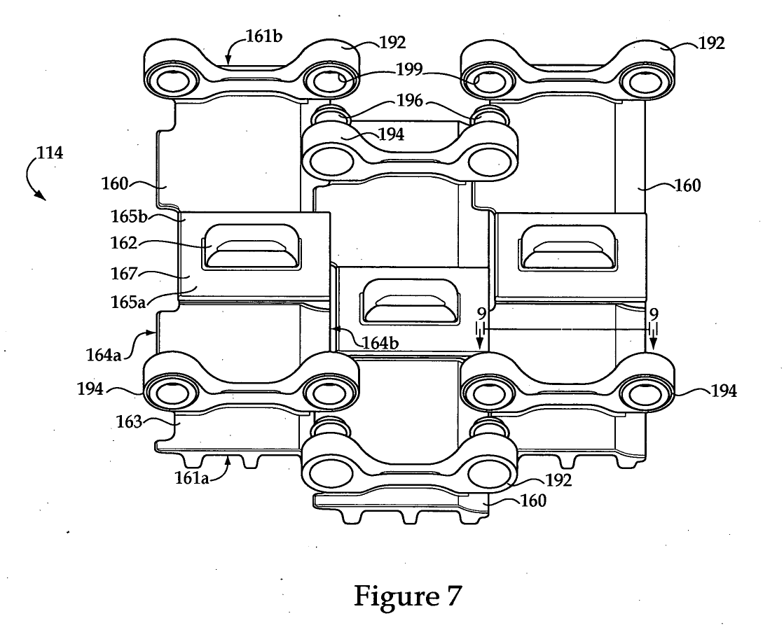

Referring now to FIG. 7, there is shown an alternative design that includes a segment of a track 114, also including a plurality of coupled together track shoes 160. In FIG. 7, three track shoes 160 are shown, each of which includes a pad 167, first and second rails 165a and 165b, and a guide block 162. The design of the segment of track shown in FIG. 7 differs from that of the FIG. 3 embodiment in several ways, most significantly in that each track shoe 160 includes a one-piece casting that includes a pad 167, a guide block 162 and first and second track links. In one embodiment, each track shoe 160 may consist of a one-piece casting that also includes an outboard track link 192 and an inboard track link 194. Other versions are possible, wherein each guide block is a separate piece, which bolts to a one-piece integral shoe and pad, or still other combinations. The respective inboard and outboard track links 192, 194 may be spaced different distances from a center of the corresponding track shoe 160, approximately a center of each guide block 162. In the embodiment shown in FIG. 7, every other shoe casting 160 may include track pins 196, either formed integrally therewith or as separate pieces, for coupling the corresponding track shoe 160 with adjacent shoes via engagement between the links of the corresponding track shoes with pins 196. In the embodiment shown in FIG. 7, track pins 196 may be positioned within bores 199 of adjacent track links, which may be both inboard links 194 and outboard links 192. Each track shoe 160 may also include a front edge 164a and a back edge 164b, together with outboard edges 161a and 161b defining a footprint for the corresponding track shoe 160. Similar to other embodiments described herein, each of track shoes 160 may include a ground contact area equal to its footprint.

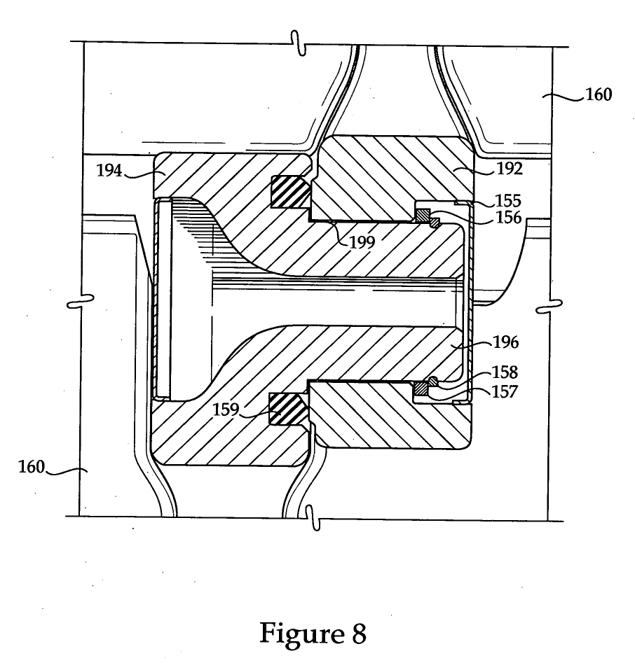

Turning now to FIG. 8, there is shown a sectioned view taken approximately through a middle of one of pins 196 shown in FIG. 7, in a section plane extending in a direction parallel to edges 164a and 164b. In the embodiment shown in FIG. 8, pin 196 is an integral part of an inboard link 194, but it could just as well consist of a separate piece. Each pin 196 may be positioned within a bore 199 in link 192, and retained therein via a snap ring 156 positioned within a groove 158 adjacent a thrust bearing 157. An end cap 155 may be used to seal bore 199 at a first end, whereas an annular seal 159 may be positioned approximately opposite end cap 155, between links 192 and 194. During assembly, adjacent track links can be pressed toward one another to compress seal 159, then snap ring 156 positioned within its corresponding groove 158 and end cap 155 pressed or threaded into engagement with link 192, for example. It should be appreciated that a wide variety of designs are contemplated relating to the positioning of pins 196, the relative positioning of links 192 and 194, and a variety of other factors. It is contemplated, however, that locating links 192 and 194, as well as pins 196, approximately as shown in FIG. 7 will provide for a practical assembly strategy, as seals 159 may be readily compressed by pressing adjacent track shoes 160 together. In certain earlier designs, for example with fork and blade track chains, the relatively fixed position of certain of the track components prevents seals about the pins and other components from being easily compressed. As a consequence, many earlier tracks are “dry” tracks, or only grease-lubricated and suffer from the disadvantages attendant to inferior lubrication strategies, such as decreased wear life.

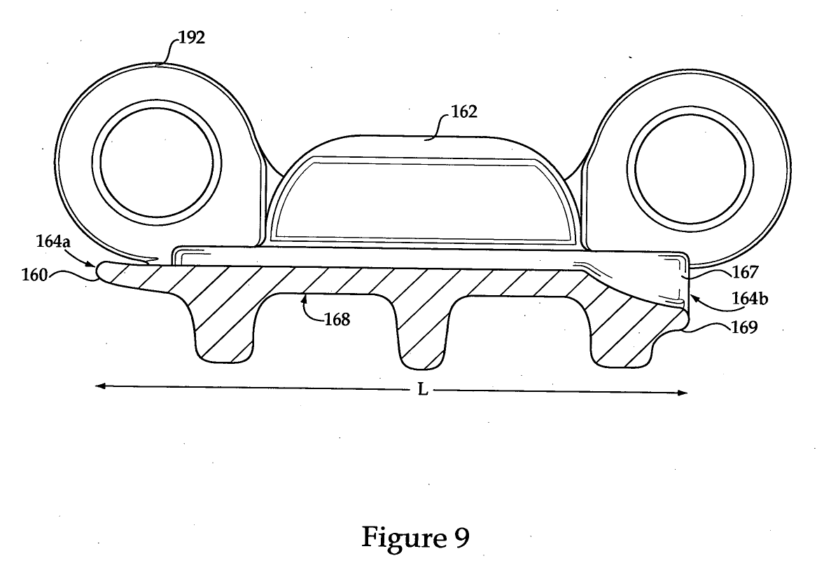

Turning now to FIG. 9, there is shown a sectioned view of a track shoe 160 taken approximately along line 9-9 of FIG. 7. As mentioned above, each track shoe 160 may include a front edge 164a and an opposite back edge 164b, and may further have a lower side 168 whereupon a plurality of grousers 169 are located. Since lower side 168 provides a continuous lower surface for each track shoe 160, the entire footprint defined by the each track shoe 160 is available as a ground contact area and accordingly distributes weight of a machine associated with track 114 over a relatively large surface area. This contrasts with certain earlier designs wherein portions of the lower side of each track shoe included voids which would not ordinarily contact the ground. It will also be noted from FIG. 9 that back edge 164b has a scalloped shape in cross section. This shape allows interference with a front edge of an adjacent track shoe to be minimized when the adjacent track shoes are moved relative to one another. As a result, track shoes may be positioned relatively close together, reducing gaps therebetween.

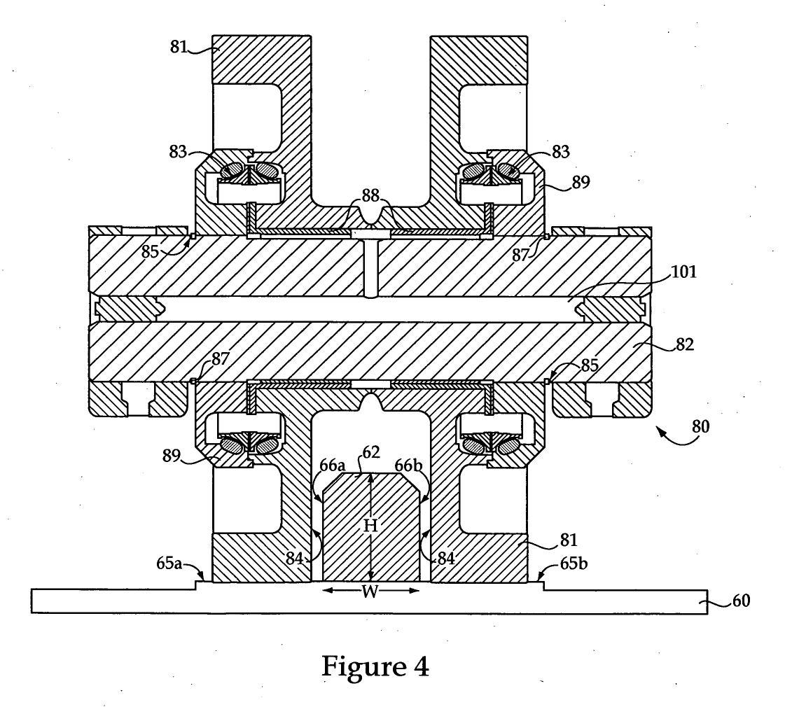

Referring now to FIG. 4, there is shown a sectioned view of a track roller 80 according to the present disclosure, illustrating certain of the unique aspects thereof. While the following description discusses track roller 80 in the context of tracks 14a, 14b, it should be appreciated that track roller 80 is similarly applicable to other track embodiments contemplated herein. Each track roller 80 may have a configuration such that it straddles each guide block 62 of the corresponding track, and includes rims or tread portions 81 positionable on opposite sides of each guide block 62, to ride upon rails 65a and 65b. Track roller 80 may further include a pin 82 configured for coupling with track roller frame 22 in a conventional manner, pin 82 being retained with tread portions 81 via snap rings 85 positionable within annular grooves 87. Each pin 82 may further include an interior passage 101 to permit lubricating oil to be supplied to internal components of roller 80. Roller 80 may further include bearings 88 positionable between tread portions 81 and pin 82, as well as seals 83 retained upon pin 82 via seal carriers 89 adjacent snap rings 85. Seal carriers 89 may be press fit with pin 82.

Track roller 80 may guide track 14a, 14b, via inboard guiding surfaces 84 positioned adjacent first and second guiding surfaces 66a and 66b of each guide block 62. It may be noted from the FIG. 4 illustration that each guide block 62 has a height H which is approximately equal to its width W. Roller guiding surfaces 66a and 66b extend upwardly from rails 65a and 65b, respectively, each of guiding surfaces 66a and 66b having a height equal to at least one half width W of guide block 62. A relatively large interface between roller guiding surfaces 66a and 66b and inboard surfaces 84 improves track guiding as compared to earlier designs having relatively smaller guiding surfaces between track rollers and track components.

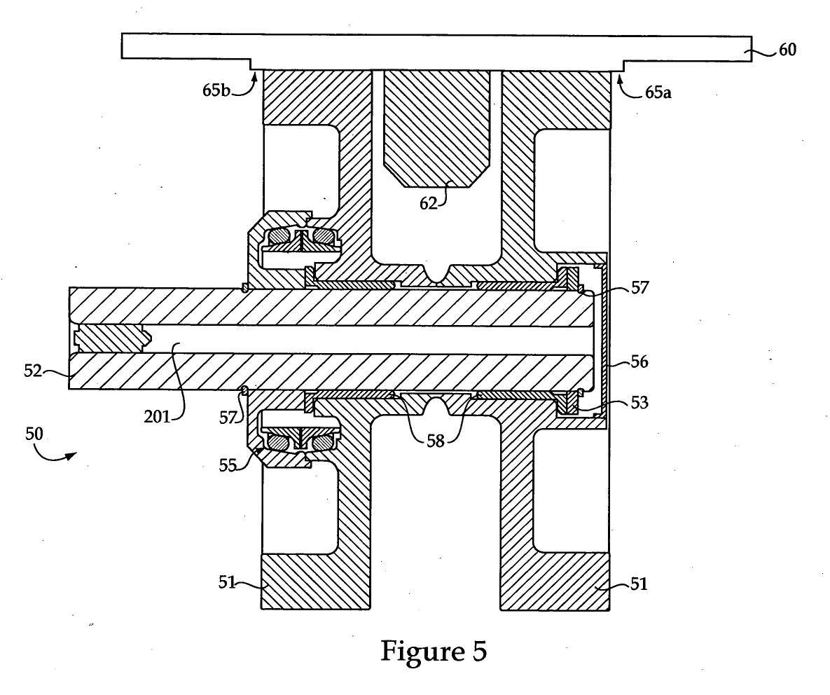

Referring now to FIG. 5, there is shown a sectioned view of a carrier roller 50 according to one embodiment. Carrier roller 50 may include rims or tread portions 51 straddling each guide block 62. Carrier roller 50 may also be configured for cantilevered mounting via a pin 52 having bearings 58 for rotatably supporting tread portions 51. Tread portions 51 may contact rails 65a and 65b of the corresponding track and straddle guide blocks 62 in a manner similar to that of track rollers 80. Pin 52 may further include an internal passage 201 to supply oil to bearings 58 and other components. A snap ring 57 may be positioned adjacent a seal 55 at one side of roller 50, and another snap ring 57 positioned at an opposite side of roller 50 to retain tread portions 51 on pin 52. Seal 55 may comprise a seal carrier press fit with pin 52. A thrust bearing 53 may be positioned adjacent the rightmost one of snap rings 57, and an end cap 56 may be engaged with one of tread portions 51 at a location opposite seal 55.

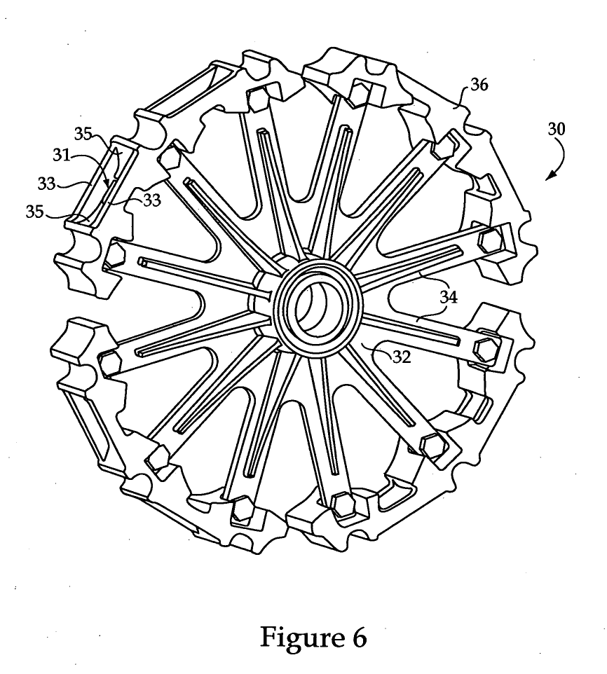

Turning now to FIG. 6, there is shown an idler 30 suitable for use with machine 10 and track 14a, 14b shown in FIG. 1, as well as the other track systems contemplated herein. Idler 30 may include a hub portion 32 having a plurality of spokes 34 extending therefrom. A plurality of arcuate track contacting segments 36 are provided which may each be bolted to a plurality of spokes 34. Each track contacting segment 36 may include a pocket 35 located between spokes 34 which is configured to receive guide blocks 62 during operation of track 14a, 14b. Each of pockets 31 may be defined in part by opposite lateral guide walls 33 and also in part by front and back end walls 35. In general, guide walls 33 may engage against roller guiding surfaces 66a and 66b of each guide block 62, as shown in FIG. 4. Front and back end walls 35 may engage with ends of each guide block 62. In most embodiments, segments 36 will not contact track shoes of an associated track, but will only contact guide blocks thereof. Drive sprocket 40 may have a configuration and components similar to that of idler 30. Returning to FIG. 2, it may be noted that drive sprocket 40 is shown also having a plurality of arcuate track contacting segments 236 coupled with a hub portion 232. In the case of drive sprocket 40, front and back end walls of pockets in segments 236 may engage with guide blocks 62 for applying drawbar force to the corresponding track 14a, 14b.

### INDUSTRIAL APPLICABILITY

Track systems according to the present disclosure are considered to provide a variety of advantages over known designs, in particular with regard to conditions often encountered with excavating machines. Not only do tracks 14a, 14b, 114 and other track systems contemplated herein have track shoes 60, 160 providing relatively large ground contact areas to distribute ground pressure, they are relatively lightweight, strong and resistant to repetitive vertical loading, typical of excavator operation. In contrast to many earlier designs, rather than locating rails on track links, rails are integral with the track shoes, allowing track chains to serve the primary purpose of coupling together the track shoes and transmitting drawbar forces through the track. In excavators in particular, track life tends to relate to both wear and structural failure. The present disclosure offers both improved wear life, and improved resistance to structural failure and damage, promising an extended service life for excavator and other tracks, without sacrificing with regard to cost and weight.

Since track rollers 80 directly contact rails 65a, 165a, 65b, 165b, rollers 80 will tend to have larger outer diameters than certain earlier designs having rails located on track chains elevated from the track shoes. Greater diameter generally corresponds to a slower roller rotational speed and a greater perimeter having a greater amount of total wear area for a given track roller. These features tend to translate into greater service life for track rollers 80 as well as carrier rollers 50, given the greater amount of wear material and lesser demands on associated seals and bearings. The design of track rollers 80 and carrier rollers 50 also minimize packing of material in undercarriage 11, as the rotating components are generally open outboard of blocks 62, allowing material to be ejected rather than packed in amongst track components such as extra track chains. Since segments 36 and 236 of idler 30 and sprocket 40 typically do not touch the corresponding track shoes, they also resist packing during operation, allowing material to be ejected through the space between shoes 60, 160 and segments 36, 136, as well as through segments 36, 136 themselves.

It should further be understood that while tracks 14a, 14b and related components of track systems described herein will commonly be designed and built for use with new machinery, the present disclosure is not thereby limited and retrofit applications are contemplated. To retrofit an existing machine with a track system according to the present disclosure, track rollers 80 and carrier rollers 50 may need to be positioned away from track roller frame 22 to maintain an existing track envelope. To achieve the repositioning of rollers 80 and 50, spacers may be coupled with frame 22 to adjust the relative positions of the axes of rollers 80 and 50 away from frame 22.

Sprocket 40 may have a relatively larger diameter than certain conventional sprockets, as its arcuate segments 236 will typically be positioned relatively further from hub 232 than certain conventional designs to allow engagement with blocks 62, 162. To accommodate a relatively larger diameter sprocket, track roller frame 22 may need to be modified to position an axis of sprocket 40 relatively more forward than that of the previous sprocket, or portions of the bulkheads about sprocket 40 may need to be removed, to ensure that sprocket 40 does not collide with portions of roller frame 22. Idler 30 may too have a relatively larger diameter than a conventional-diameter idler removed from a machine to be retrofitted with a track system according to the present disclosure. Tracks according to the present disclosure will also tend to be longer than the tracks for which they are substituted. To accommodate the relatively longer track, an existing idler mounting system may be adjusted to position an axis of rotation of idler 30 at a location relatively further forward than that associated with the idler to be replaced.

The present description is for illustrative purposes only, and should not be construed to narrow the breadth of the present disclosure in any way. Thus, those skilled in the art will appreciate that various modifications might be made to the presently disclosed embodiments without departing from the intended spirit and scope of the present disclosure. For instance, while the foregoing description discusses casting and forging of certain track components, the present disclosure is not limited to any particular forming technique, and certain elements such as track shoes 60 might be rolled, whilst other components such as blocks 62 and pads 67 might be cast, etc. Other aspects, features and advantages will be apparent upon an examination of the attached drawings and appended claims.

What is claimed is:

1. A machine track system comprising:
a plurality of track shoes having a first outboard edge and a second outboard edge, each of said track shoes further including a first rail and a second rail located between said first and second outboard edges;
a plurality of guide blocks coupled one with each of said shoes and positioned between said rails;
said plurality of track shoes being coupled together with a total of two track chains, including a first track chain spaced outboard of said first rail and a second track chain spaced outboard of said second rail; and
said track chains each including a plurality of links having first and second ends, the ends of each link being arranged side-by-side with ends of adjacent links and coupled therewith via track pins.

2. The machine track system of claim 1 comprising a ground engaging track, wherein each of said track shoes includes a ground engaging lower side and an opposite upper side, and wherein each of said rails is located on a pad positioned on said upper side.

3. The machine track system of claim 2 wherein each of said rails has a width, wherein said first track chain is spaced an average distance from said first rail which is greater than said width, and wherein said second track chain is spaced an average distance from said second rail which is greater than said width.

4. The machine track system of claim 3 wherein said first and second track chains are spaced an average distance from the respective first and second rails which is greater than twice said width.

5. The machine track system of claim 2 wherein each of said track shoes has a front edge and a back edge, said front and back edges and said outboard edges defining a footprint, and wherein the ground engaging lower side of each of said track shoes has a ground contact area equal to said footprint.

6. The machine track system of claim 2 wherein each of said track chains comprises straight inboard links alternating with straight outboard links.

7. The machine track system of claim 5 wherein each of said track shoes comprises a casting that includes, one of said guide blocks and said rails.

8. The machine track system of claim 7 wherein each of said track shoes comprises a one-piece casting that includes a first link adjacent its first outboard edge and a second link adjacent its second outboard edge, wherein said first and second links are spaced different distances from the corresponding guide block.

9. The machine track system of claim 2 comprising a plurality of track rollers straddling said guide blocks and contacting said rails, wherein each of said guide blocks has a width and includes roller guiding surfaces extending upwardly from said rails, and wherein the roller guiding surfaces of each guide block have a height equal to at least one half the width of the guide block.

10. The machine track system of claim 9 comprising a drive sprocket and at least one idler engaged with said track, each of said sprocket and said at least one idler including a hub and a plurality of arcuate track contacting segments bolted thereto, said arcuate track contacting segments including pockets configured to receive said guide blocks.

11. A machine comprising:
a frame;
at least one track coupled with said frame and having a plurality of track shoes each with a first outboard edge and a second outboard edge, said track shoes further including rails located between the respective first and second outboard edges;
a plurality of guide blocks coupled one with each of said track shoes and positioned between the rails thereof;
a plurality of track rollers contacting said rails; and
a first track chain and a second track chain, said track chains being spaced from said rails and each including a plurality of links having ends arranged side-by-side with ends of adjacent links and coupled therewith via track pins.

12. The machine of claim 11 comprising an excavating machine wherein said at least one track comprises a first ground engaging track positioned at a first side of said frame and a second ground engaging track positioned at a second side of said frame, and wherein the track shoes of each of said tracks are coupled together with a total of two track chains.

13. The machine of claim 12 wherein said plurality of track rollers straddle the guide blocks of the corresponding track, said machine further comprising:
a plurality of carrier rollers also straddling the guide blocks and contacting rails of the corresponding track; and
at least one idler and a drive sprocket associated with each of said tracks;
wherein said idlers and said drive sprockets each include a plurality of arcuate track contacting segments having pockets therein configured to receive the guide blocks of the corresponding track.

14. The machine of claim 12 comprising a plurality of pads located on each of said track shoes, said pads adjoining the corresponding guide block and having the rails of the corresponding track shoe located thereon.

15. The machine of claim 14 wherein said pads each have a width, and wherein each of said track shoes has a width extending between its outboard edges which is at least three times the width of said pads.

16. A machine track segment comprising:
a track shoe having a plurality of peripheral edges defining a footprint, including a first outboard edge, a second outboard edge, a front edge and a back edge, said track shoe having a length extending between said front and back edges and a width extending between said first and second outboard edges which is at least twice said length, and a ground contact area equal to said footprint;
a guide block positioned between said first and second outboard edges; and
at least one pad adjoining said guide block, said at least one pad having a width less than one third the width of said track shoe, and including a first rail positioned between said guide block and said first outboard edge and a second rail positioned between said guide block and said second outboard edge, wherein said track shoe is adapted to couple with adjacent track shoes of a machine track via a total of two track chains separate from and spaced outboard of said rails.

17. The machine track segment of claim 16 further comprising a first track link bolted to said track shoe adjacent said first outboard edge and a second track link bolted to said track shoe adjacent said second outboard edge.

18. The machine track segment of claim 16 comprising a casting that includes said track shoe, said guide block and said at least one pad.

19. The machine track segment of claim 18 wherein said casting includes a first track link adjacent said first outboard edge, and a second track link adjacent said second outboard edge.
